(19) United States
(12) Patent Application Publication
(10) Pub. No.: US 2001/0034163 A1
(43) Pub. Date: Oct. 25, 2001

(54) Battery connector

(76) Inventor: Chun-Hsiang Chiang, Taipei Hsien (TW)

Correspondence Address: Stephen Z. Weiss, MOLEX INCORPORATED, 2222 Wellington Court, Lisle, IL, 60532, US

(21) Appl. No.: 09/799,403

(22) Filed: Mar. 5, 2001

(30) Foreign Application Priority Data
Mar. 3, 2000 (TW) 89203389

(51) Int. Cl. H01R 24/00; H01R 33/00

(52) U.S. Cl. 439/660

(57) ABSTRACT

An electrical connector is provided which includes an insulating housing having at least one terminal receiving portion formed by a first insert groove and a second insert groove communicated with the and first a second insert groove, and a conductive terminal received in said at least one terminal receiving portion and including a body, a connecting arm, a connecting portion and a conducting portion. The second insert groove has a first end. The body is located in the first insert groove, and has a first side and a second side opposite to the first side. The connecting extends transversely from the second side of the body in a direction distal to the first side of the body. The connecting portion extends from the first side of the body in a direction distal to the second side of the body, and can achieve electrical connection with a circuit board. The conducting portion extends upwardly from a free end of the connecting arm into the second insert groove. The conducting portion includes a guiding portion which extends from the second insert groove to the first insert groove and which is proximate to the first end of the second insert groove, and a contact portion which is farther away from the first end than the guiding portion such that the conducting portion can achieve electrical contact with a matching terminal inserted via the first end of the second insert groove into the second insert groove. Thus, insertion of the electrical connector is smooth; the normal contact force of the conductive terminal can be increased; and poor electrical contact can be effectively prevented.

### FIELD OF THE INVENTION

The present invention provides a battery connector more particularly a battery connector with terminals capable of providing a relatively large normal contact force.

### BACKGROUND OF THE INVENTION

Battery connectors are adapted for interconnecting an electrical device and a battery. FIG. 1 shows a conventional battery connector that includes a plug connector 1 and a socket connector 2 for matching the plug connector 1. The plug connector 1 is generally secured on a circuit board of an electrical device (such as the mother board of a notebook computer) and the socket connector 2 is provided at an output end of a battery. The plug connector 1 has a plurality of spaced-apart juxtaposed metal blade terminals 11. The socket connector 2 is provided with a plurality of insert grooves 21 corresponding to the metal blade terminals 11. The insert grooves 21 are defined by a plurality of juxtaposed spacer plates 22 that are spaced apart from each other. Each of the spacer plates 22 has a terminal 23 insertably disposed therein. The terminal 23 extends into the insert groove 21 to conduct electricity when the metal blade terminal 11 of the plug connector 1 is inserted into the insert groove 21 to enable supply of electricity to the electrical device.

In U.S. Pat. No. 5,551,883, a cantilever type terminal is disclosed. FIG. 2 shows the insert grooves 21 and a terminal 23 of a socket connector 2. The terminal 23 includes a body 231 secured in a receiving groove 221 of a spacer plate 22, a solder portion 232 extending rearwardly of a rear side of the body 231, and a resilient arm 233 extending obliquely into the insert groove 21 from a front side of the body 231 adjacent to a bottom edge thereof (i.e., the resilient arm 233 extends gradually forward and upward and gradually away from the receiving groove 221 into the insert groove 21). In addition, the rear end of the resilient arm 233 forms a contact portoin234 for connection with the metal blade terminal 11. A free end of the contact portion 243 is bowed to form a securing portion 235 that extends toward the receiving groove 221 of the spacer plate 22 and that is adapted to engage the receiving groove 221. The receiving groove 221 of the spacer plate 22 is configured to match the terminal 23. by virtue of this arrangement, with reference to FIGS. 3 and 4, when the terminal 23 is inserted into the receiving groove 221 of the spacer plate 22, the body 231 of the terminal 23 and the securing portion 235 are retained in the receiving groove 221, whereas the solder portion 232 projects from the socket connector 2. Besides, the resilient arm 233 is located between the receiving groove 221 and the insert groove 21, whereas the contact portion 234 is located in the insert groove 21. As such, during the process of gradual insertion of the metal blade terminal 11 of the plug connector 1 into the insert groove 21, the metal insert plate 11 will first contact the contact portion 234 projecting from the insert groove 21. Hence, the force applied to push the contact portion 234 into the receiving groove 21 has to be augmented. Subsequently, the metal blade terminal 11 continues to advance until it is fully inserted into the insert groove 21. Due to the pushing action, the resilient arm 233 deflects and generates a normal contact force to push the contact portion 234 into contact with the metal insert plate 11, thereby establishing electrical contact between the plug connector 1 and the socket connector 2.

However, the conventional battery connector has the following disadvantages:

1. Obstructed insertion. Since the resilient arm 233 of the terminal 23 extends from the inside to the outside (i.e., from the rear to the front), which is opposite to the direction of insertion of the metal blade terminal 11 of the plug connector 1 into the insert groove 21 from the outside to the inside, once the metal blade terminal 11 enters the insert groove, it is obstructed by the contact portion 234 projecting from the terminal 23 into the insert groove 21 and cannot advance any further. Therefore, a greater force has to be applied in order to continue pushing of the blade terminal 11 onward, thereby hindering smooth mating of the plug connector 1 with the socket connector 2.

2. Weak normal contact force of the terminal. Since the length (I) of the resilient arm 233 of terminal 23 must be sufficient in order for the contact portion 234 to be in the vicinity of the front end portion of the insert groove 21 to facilitate connection of metal blade terminals 11 of the plug connector 1, the length (I) of the resilient arm 233 is relatively long. Since the arm of force of the resilient arm 233 is relatively long, i.e., the distance of the contact portion 234 from its fulcrum point is relatively long, the normal contact force of the contact portion 234 will be decreased with an increase in the length of the arm of force. Furthermore, as the length of the resilient arm 233 is relatively long and as the width of the insert groove 21 is fixed, the amount of displacement of the contact portion 234 toward the receiving groove 221 when pushed by the metal insert plate 11 is limited. Therefore, the normal contact force produced upon the displacement of the resilient arm 233 when the resilient arm 233 is pushed is likewise small. Hence, it is likely that the contact portion 234 cannot maintain good contact with the metal blade terminals 11, thereby resulting in poor electrical contact.

### SUMMARY OF THE INVENTION

An object of the present invention is to provide an electrical connector which can achieve smooth insertion of the electrical connector.

Another object of the present invention is to provide an electrical connector which can increase the normal contact force of the terminals.

A further object of the present invention is to provide an electrical connector which can effectively prevent poor electrical contact.

According to one aspect of the present invention, an electrical connector is provided, wherein a conducting portion extends upwardly from a free end of a connecting arm of a conductive terminal into a second insert groove such that the conducting portion is entirely within a front end portion of the second insert groove to thereby reduce the length of arm of force of the conducting portion, hence increasing the normal contact force of the terminal and effectively preventing poor electrical contact.

According to another aspect of the present invention an electrical connector is provided, wherein the conducting portion of the conductive terminal includes a guiding portion and a contact portion The guiding portion extends from the second insert groove to the first insert groove and is closer to a front wall surface of an insulating housing than the contact portion so as to achieve smooth insertion.

According to a further aspect of the present invention an electrical connector is provided, wherein a side of the conducting portion of the conductive terminal which faces the second insert groove is formed with a surface projects toward the second insert groove so as to increase the normal contact force and to effectively prevent poor electrical contact.

Accordingly, an electrical connector of the present invention includes an insulating housing and at least one conductive terminal. The insulating housing has at least one terminal receiving portion. The terminal receiving portion includes a first insert groove and a second insert groove communicated with the first insert groove. The second insert groove has a first end and a second end opposite to the first end. Said at least one conductive terminal is disposed to be received in said at least one terminal receiving portion. Said at least one conductive terminal includes a body, a connecting arm, a connecting portion and a conducting portion. The body is located in the first insert groove and has a first side a second side opposite to the first side. The connecting arm extends transversely from the second side of the body in a direction distal to the first side of the body The connecting portion extends from the first side of the body in a direction distal to the second side of the body, and can achieve electrical connection with a circuit board The conducting portion extends upwardly from a free end of the connecting arm into the second insert groove. The conducting portion includes a guiding portion and a contact portion. The guiding portion extends obliquely from the second insert groove into the first insert groove, and is closer to the first end of the second insert groove than the contact portion. When a matching terminal is inserted via the first end of the second insert groove in the direction of the second end, the terminal can be guided by the guiding portion to achieve smooth insertion, and can achieve electrical contact with the conducting portion.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a connector of the prior art.

FIG. 2 is a partially exploded perspective view of the socket connector of FIG. 1.

FIG. 3 shows the connector of FIG. 2 in an assembled state.

FIG. 4 is a top sectional view of the connector of FIG. 2 after assembly.

FIG. 5 is an exploded perspective view of the first preferred embodiment of the present invention.

FIG. 6 is a partly sectional view of an insulating housing of FIG. 5.

FIG. 7 is the same sectional view as FIG. 6, but with a conductive terminal assembled thereto.

FIG. 8 is a perspective view illustrating the battery connectors according to the present invention in a mated state.

FIG. 9 is a partial sectional view illustrating the relationship between the mating terminal of the plug connector and the conductive terminal of the socket connector prior to electrical engagement.

FIG. 10 is another partial sectional view illustrating the relationship between the terminal of the plug connector and the conductive terminal of the socket connector after electrical engagement.

FIG. 11 is a perspective view showing another example of a connecting portion of the conductive terminal according to the first preferred embodiment of the present invention.

FIG. 12 is a schematic perspective view of the second preferred embodiment of a conductive terminal according to the present invention.

FIG. 13 is a schematic perspective view of the third preferred embodiment of a conductive terminal according to the present invention.

FIG. 14 is a schematic perspective view of the fourth preferred embodiment of a conductive terminal according to the present invention.

FIG. 15 illustrates electrical contact between a schematic view of a matching terminal of a plug connector and the conductive terminal of FIG. 14.

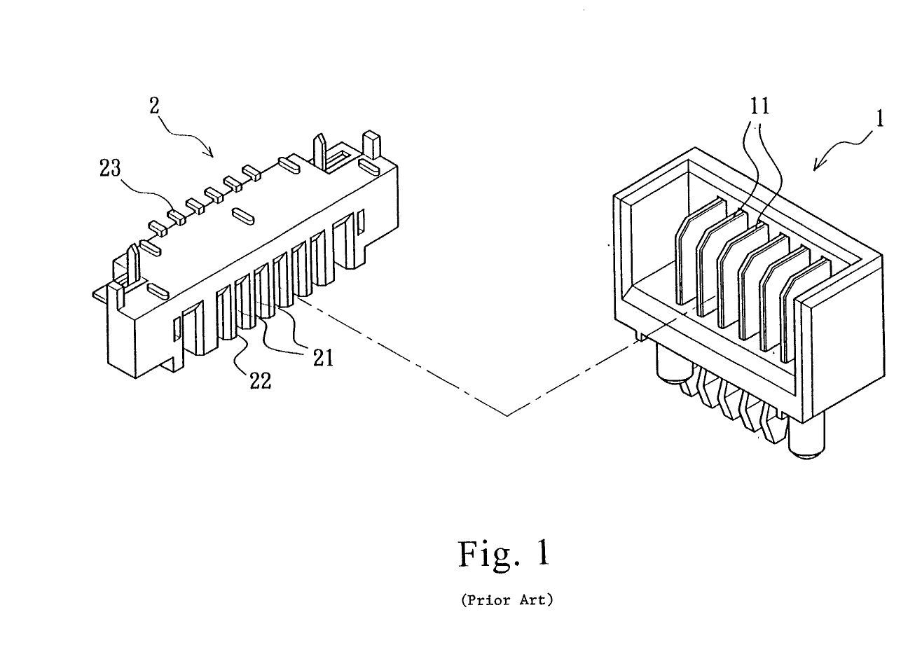

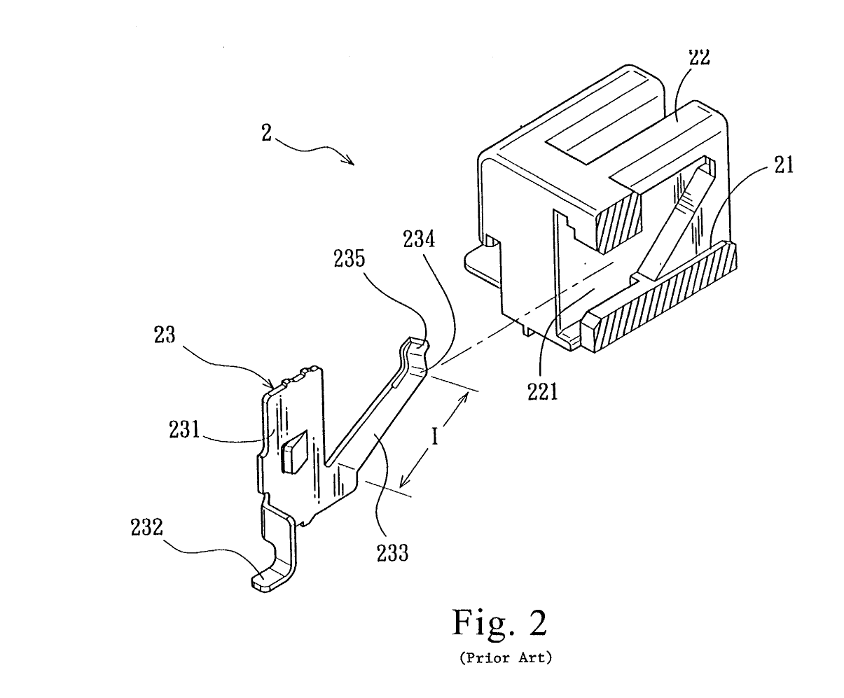

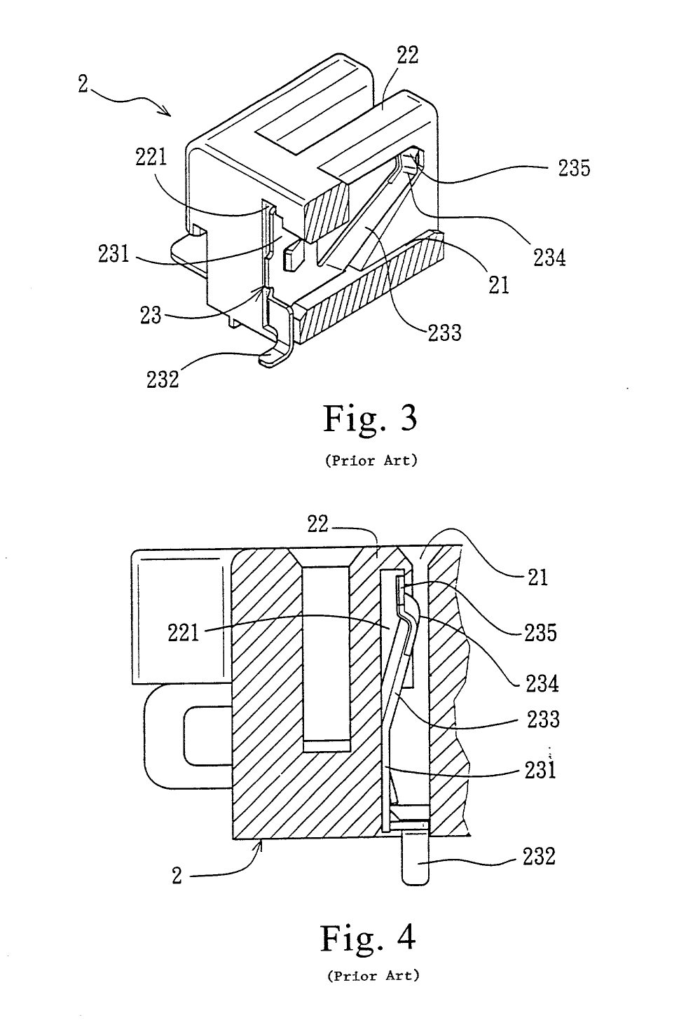

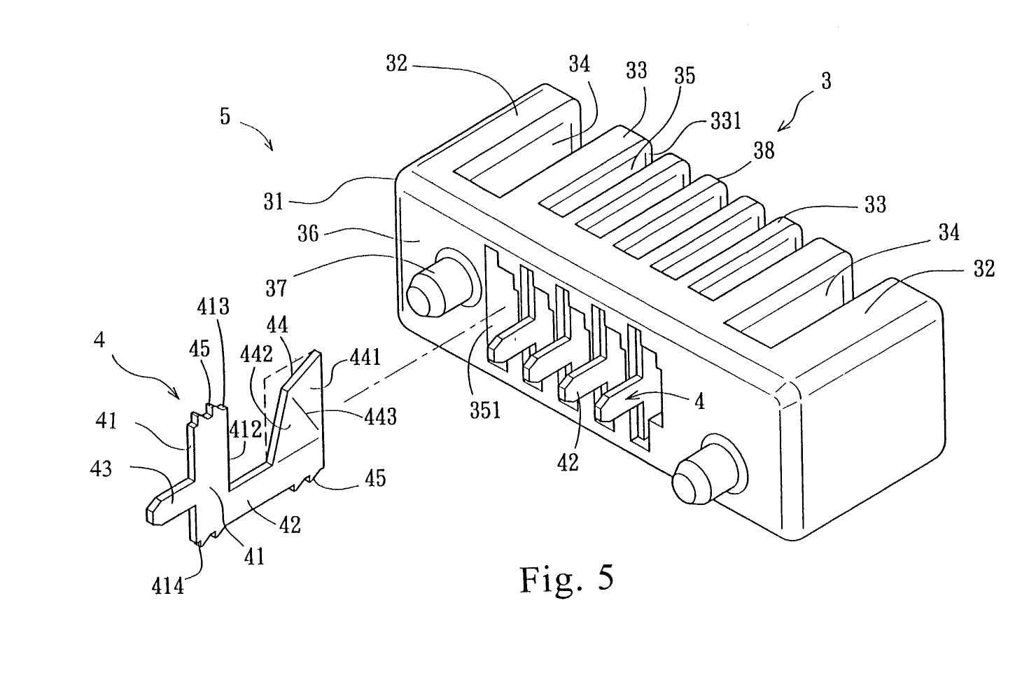

Reference is made to FIG. 5, which is a partially exploded view of a preferred embodiment of a battery connector 5 serving as a socket connector according to the present invention. In this embodiment, the battery connector 5 includes a socket insulating housing 3 and a plurality of conductive terminals 4.

### DETAILED DESCRIPTION OF THE PREFERRED EMBODIMENTS

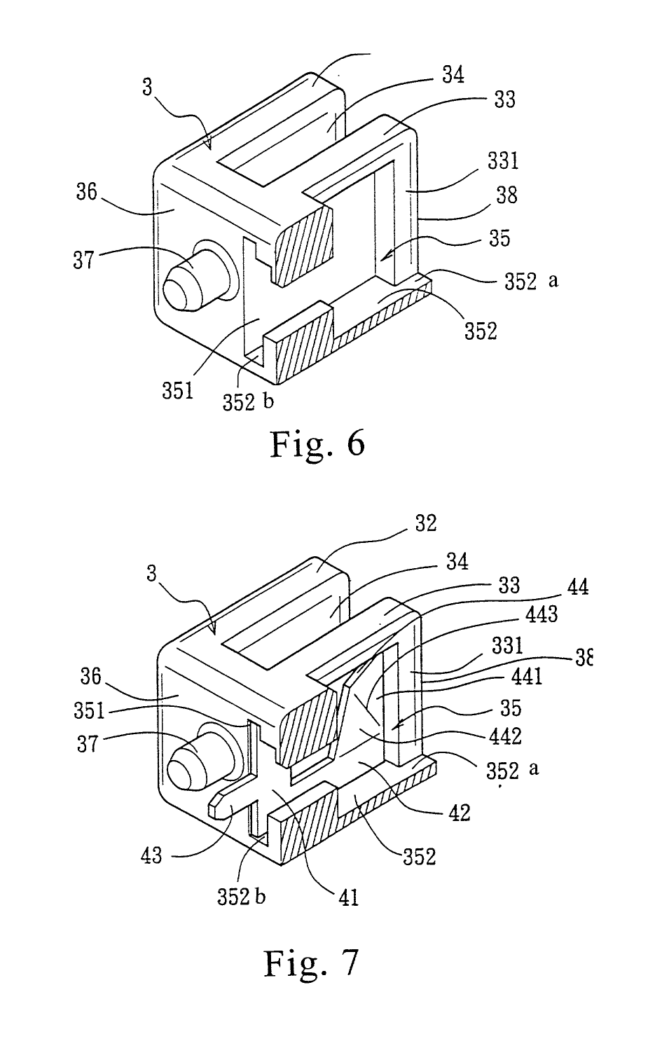

The socket insulating housing 3 has a body 31. Two side plates 32 and a plurality of spacer plates 33 disposed between the two side plates 32 extend forwardly from the body 31 in a spaced-apart and juxtaposed arrangement such that a retaining groove 34 is defined between each side plate 32 and the adjacent spacer plate 33 for mating with and positioning another battery connector (i.e., a plug connector) during coupling of the battery connectors. The insulating housing 3 further has a plurality of terminal receiving portions 35. Each of the terminal receiving portions 35 includes a first insert groove 351 and a second insert groove 352 communicated with the first insert groove 351. With reference to FIG. 6, the first insert groove 351 is provided between adjacent spacer plates 33 of the insulating housing 3, and is formed by recessing a wall surface 331 of the left spacer plate 33 facing the right spacer plate 33 until the insert groove 351 extends to a mounting face 36 of the housing 3. The second insert groove 352 is located in a spacing between two adjacent spacer plates 33, i.e., a space that extends from a front wall surface 38 in the housing 3 opposite to the mounting face 36 in a direction toward the mounting face 36 such that the second insert groove 352 has a first end 352a proximate to the front wall surface 38 and a second end 352b opposite to the first end 352a and proximate to the mounting face 36, thereby defining an insertion direction from the first end 352a to the second end 352b. Both sides of the mounting face 36 of the housing 3 are respectively provided with positioning posts 37 for positioning the battery connector 5 in circuit board engaging holes (not shown) when the battery connector 5 is coupled to the circuit board.

Each conductive terminal 4 is received in the corresponding terminal receiving portion 35 of the insulating housing 3. Each conductive terminal 4 includes a body 41, a connecting arm 42, a connecting portion 43 and a conducting portion 44.

The body 41 is located in the first insert groove 351 and is an upright body with a first side 411, a second side 412 opposite to the first side 411, and a top side 413 and a bottom side 414 that are disposed between the first side 411 and the second side 412 and that are opposite to each other. In this embodiment, the top side 413 and the bottom side 414 of the body 41 are respectively provided with two positioning portions 45 projecting therefrom for abutting against wall surfaces of the first insert groove 351. Each positioning portion 45 is preferably a projecting block.

The connecting arm 42 extends transversely from the part of the second side 412 of the body 41 that is adjacent to the bottom side 414 in a direction distal to the body 41 such that the body 41 and the connecting arm 42 together define an L-shape. In this embodiment, the body 41 and the connecting arm 42 are disposed on the same vertical plane. Therefore, the connecting arm 42 is also located in the first insert groove 351. Under this condition, a bottom side of a free end of the connecting arm 42 is also provided with two positioning portions 45 that can abut against the wall surfaces of the first insert groove 351. These positioning portions 45 are preferably projecting blocks.

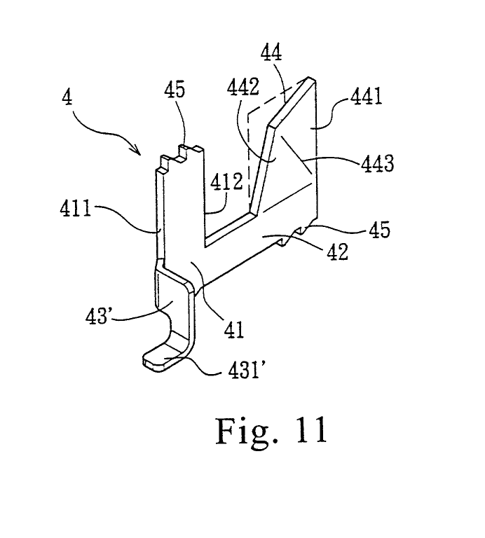

The connecting portion 43 extends from a central portion of the first side 411 in a direction distal to the second side 412 of the body 41. In this embodiment, the connecting portion 43 is an insert leg for insertion into and soldering to an aperture (not shown) in the circuit board to thereby establish electrical connection between the circuit board and the conductive terminal 4. In addition, with reference to FIG. 11, which illustrates another example of the connecting portion 43′ of the conductive terminal 4, the connecting portion 43′ has a connecting face 431′, adapted to be adhered to the circuit board at a corresponding position via surface mount technique (SMT) . As such a mounting technique is well known in the art, it will not be described in detail herein for the sake of brevity.

In this embodiment, the conducting portion 44 is a plate member that extends upwardly from the free end of the connecting arm 42 (i.e., the end of the connecting arm 42 distal to the body 41) into the second insert groove 352. In addition, the part of the conducting portion 44 that is distal to the body 41 and the connecting arm 42 (i.e., the part of the first end 352a that is proximate to the first insert groove 352) is bent and extends toward first insert groove 351 such that the conducting portion 44 is divided into a guiding portion 441 and a contact portion 442. The guiding portion 441 extends gradually from the first insert groove 351 toward the second insert groove 352 along the insertion direction (i.e., the direction from the first end 352a to the second 352b of the second insert groove 352) such that the guiding portion 441 traverses the second insert groove 352 and is closer to the first end 352a of the second insert groove 352 than the contact portion 442, and such that a surface 443 of the guiding portion 44 which faces the second insert groove 352 defines a V-shaped plane that projects toward the second insert groove 352. As such, when another battery connector is to be mated, the terminal thereof will be guided by the guiding portion 441 to facilitate smooth insertion.

Based on the aforesaid construction and relationship during assembly, the conductive terminals 4 are respectively disposed in the corresponding first insert grooves 351 exposed from the mounting face 36 of the insulating housing 3 to complete assembly. After assembly, referring to FIG. 7, the positioning portions 45 of each conductive terminal 4 will abut against the wall surfaces of the first insert groove 351 to achieve interference fit such that each conductive terminal 4 is positioned in the corresponding first insert groove 351. Besides, the connecting portion 43 will project from the mounting face 36 of the housing 3, while the conducting portion 44 will fall between the first insert groove 351 and the second insert groove 352.

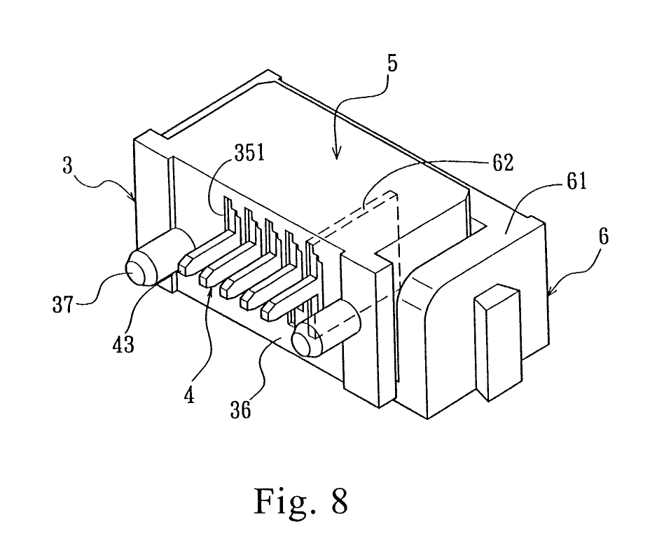

Reference is made to FIG. 8, which illustrates the socket connector 5 and ta matching plug connector 6 in a mated state. The plug connector 6 includes a plug insulating housing 61 and a plurality of spaced-apart, juxtaposed metal blade terminals 62. Since the plug connector 6 is not the focus of improvement provided by the present invention and is known in the art, a detailed description thereof is dispensed with herein for the sake of brevity. The mating of the two battery connectors 5, 6, as well as the interaction between terminals thereof, will be described in the following paragraphs.

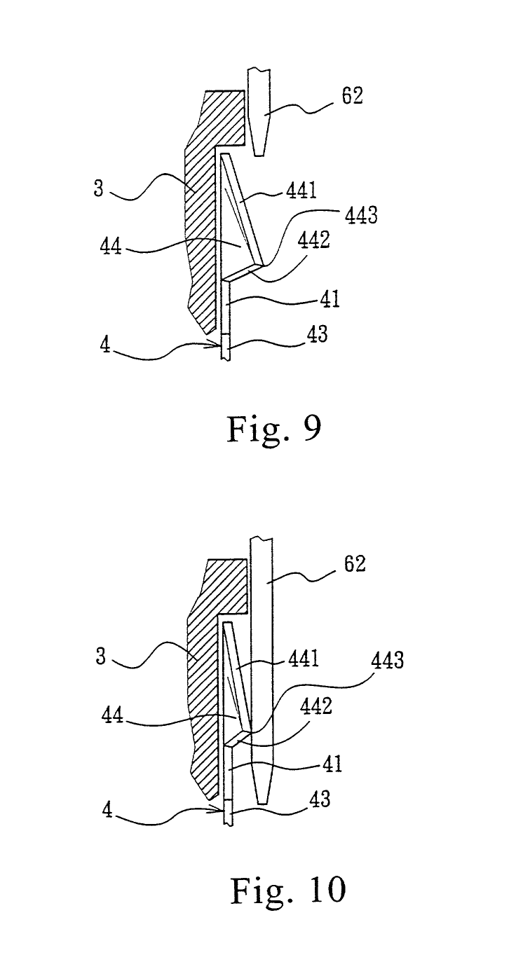

Referring to FIG. 9, when the plug connector 6 is mated with the socket connector 5, each metal blade terminal 62 of the plug connector 6 is gradually inserted into the second insert grooves 352 of the socket connector 5 along the insertion direction. After being inserted, the metal blade terminal 62 will first contact the guiding portion 441 of the conducting portion 44. As the metal blade terminal 62 is guided by the guiding portion 441, it can follow the oblique plane of the guiding portion 441 to gradually push the conducting portion 44 away from the second insert groove 352 without requiring a large amount of force and can thus proceed to advance until it is in the fully inserted state shown in FIG. 10. Hence, the present invention has the advantage of smooth insertion. During mating, as being subjected to the pressing of the metal blade terminal 62, the conducting portion 44 will displace and will deform resiliently, so that the conducting portion 44 generates a normal contact force that causes the conducting portion 44 to automatically spring back and abut against the metal blade terminal 62 , thereby resulting in contact between the conductive terminal 4 and the metal blade terminal 62 to establish electrical contact between the two battery connectors 5, 6 Furthermore, since the conducting portion 44 extends upwardly from the free end of the connecting arm 42, it is entirely within the front end portion of the second insert groove 352 to meet the requirement for good electrical contact with the metal blade terminal 62. Therefore, during mating of the two battery connectors 5, 6, the metal blade terminal 62 applies a force to press the conducting portion 44. The fulcrum point of spring force of the conducting portion 44 is at the juncture of the conducting portion 44 and the connecting arm 42. However, the fulcrum point of spring force of the resilient arm of the conventional terminal is at the juncture between the resilient arm and the body, which, as compared with the present invention, incurs an additional distance from the body to the conducting portion at the front end portion Therefore, the arm of force (i.e., distance from the conducting portion 44 to the connecting arm 42) of the conducting portion 44 according to the present invention is indeed shorter than the arm of force of the conventional resilient arm. Hence, during mating of the two battery connectors 5, 6, the normal contact force caused by displacement of the conducting portion 44 is greater than that in the prior art. In addition, when the two connectors 5, 6 are mated as shown in FIG. 10, the conducting portion 44 is pressed by the metal blade terminal 62 and is displaced toward the first insert groove 351 so that the obliquity of the oblique planes of the guiding portion 441 and the contact portion 442 is alleviated, i.e., the entire V-shaped plane 443 of conducting portion 44 facing the second insert groove 352 is deflected (i.e., the angle between the guiding portion 441 and the contact portion 442 is enlarged) when pressed by the metal blade terminal 62 Therefore, the resilient deflection will produce a normal contact force that causes the conducting portion 44 to approach the metal blade terminal 62 Thus, the normal contact force afforded by the conductive terminal 4 according to the present invention is greater than the normal contact force of the conventional cantilever type terminal.

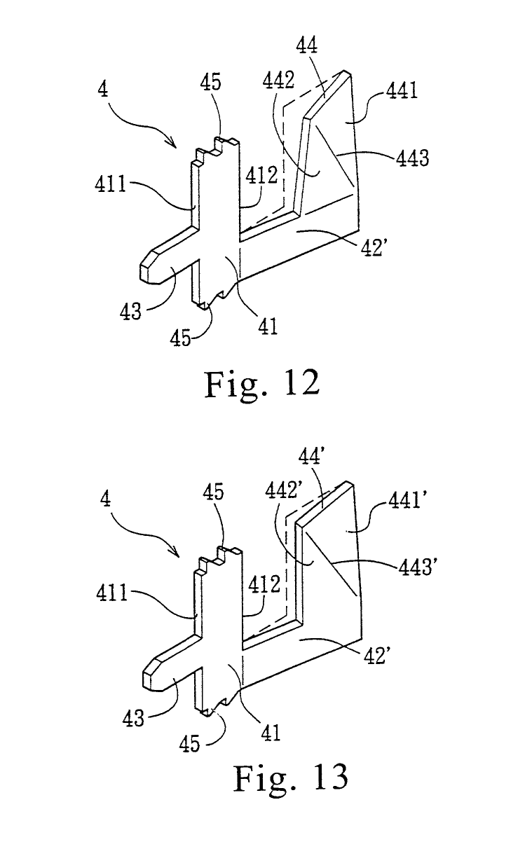

Furthermore, reference is made to FIG. 12, which shows the second preferred embodiment of the present invention. The difference between this embodiment and the previous embodiment resides in the connecting arm 42, of the conductive terminal 4. In this embodiment, in order to increase the normal contact force of the conductive terminal 4 so as to ensure good electrical contact with the corresponding metal blade terminal 62, the connecting arm 42, of each conductive terminal 4 is bent with respect to the body 41 such that the end of the free end of the connecting arm 42′ which is connected to the body 41 is closer to the second insert groove 352 (i.e., the body 41 and the connecting arm 42′ are not on the same vertical plane) . As such, when the two connectors 5, 6 are mated, the connecting arm 421 will also be displaced when pressed by the metal blade terminal 62. Such a displacement will also result in the generation of a normal contact force that brings the conducting portion 44 into tighter contact with the metal blade terminal 62.

In addition, in this embodiment, in order to facilitate displacement of the connecting arm 42′ and in view of the sufficient positioning effect provided by the positioning portions 45 on the body 41, the arrangement of the positioning portions 45 on the connecting arm 42′ can be dispensed with.

Furthermore, reference is made to FIG. 13, which shows the third preferred embodiment of the present invention. The difference between this embodiment and the previous embodiments resides in of the conducting portion 44′ of the conductive terminal 4. Since the connecting arm 42′, of the conductive terminal 4 is bent with respect to the body 41 so that the conducting portion 44′ is located in the second insert groove 352, it is not necessary to have the conducting portion 44′ extending the direction of the second insert groove 352. It is only necessary for the conducting portion 44′ extend upwardly (the conducting portion 44 extending upwardly into the second insert groove 352 in the first and second embodiments). However, the part of the conducting portion 44 portion 44′ which is distal to the body 41 and the connecting arm 42 still has to be bent toward the first insert groove 351 so as to form the guiding portion 441′ and the contact portion 442′. In this embodiment, contact portion 442′ of the conducting portion 44′ and the connection arm 42′ lie on the same vertical plane.

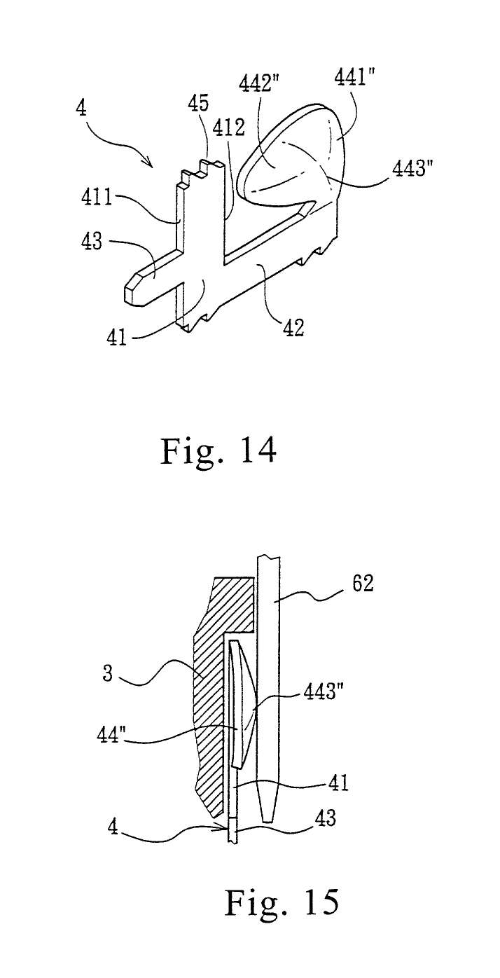

Finally, reference is made to FIG. 14 which illustrates the fourth preferred embodiment. The difference between this embodiment and the previous embodiments resides in the conducting portion 44′. The conductive portion 441′ extends upwardly from the free end of the connecting arm 42 and toward the second insert groove 352 for a certain distance and then reverses to extend in a direction toward first insert groove 351. As shown in FIG. 15, the surface of the conducting portion 441′ facing the second insert groove 352 is a curved plane bulging toward the second insert groove 352.

Accordingly, the present invention has the following advantages.

1. Smooth mating of connectors. As the direction of extension of the guiding portion 441 of the conducting portion 44 of each of the conductive terminals 4 in the socket connector 5 is the same as the direction of insertion of the metal blade terminal 62 of the plug connector 6, the metal blade terminal 62 of the plug connector 6, without requiring a large amount of force, can advance smoothly inward along the guiding portion 441 and push the conducting portion 44 gradually away from the second insert groove 352 until it is completely inserted thereinto. Thus, the present invention has the advantage of smooth insertion.

2. The conductive terminals have a greater normal contact force. Since the length of the conducting portion 44 of each of the conductive terminals 4 according to the present invention is configured to be shorter than the length of the resilient arm of the conventional cantilever type terminal, and since one surface (i.e., the surface 443′, 443 of the conducting portion 44, 44′, 441′ facing the second insert groove 352) of the conducting portion 44, 44′, 44′ according to the present invention is resiliently deflected, the normal contact force of the conductive terminal 4 according to the present invention is greater than the normal contact force of the conventional terminal. In addition, the bending of the connecting arm 42′, 42″ can be utilized to increase the normal contact force. Therefore, the conductive terminal 4 of the present invention has the effect of increased normal contact force.

3. Effectively preventing poor electrical contact. As the conductive terminals 4 have a greater normal contact force by virtue of the construction of the present invention, when two battery connectors are being mated, the conductive terminals 4 can positively contact the metal blade terminals 62 of the plug connector 6. Besides, the connecting arms 42′, 42″ can be bent so as to increase the normal contact force of the blade terminals 62 of another battery connector 6 to ensure tight contact between the terminals of the two connectors 5, 6 to thereby effectively prevent occurrence of poor electrical contact.

It will be understood that the invention may be embodied in other specific forms without departing from the spirit or central characteristic thereof. The present examples and embodiments, therefore, are to be considered in all respects as illustrative and not restrictive, and the invention is not to be limited to the details given herein.

I claim:

1. A battery connector, comprising:
an insulating housing having at least one terminal receiving portion, said terminal receiving portion including a first insert groove and a second insert groove communicated with said first insert groove, said second insert groove having a first end and a second end opposite to the first end; and
at least one conductive terminal disposed in said at least one terminal receiving portion, said at least one conductive terminal including:
a body located in said first insert groove and having a first side and a second side opposite to said first side;
a connecting arm extending transversely from said second side of said body in a direction distal to said first side of said body;
a connecting portion that extends from said first side of said body in a direction distal to said second side of said body and that can achieve electrical connection with a circuit board; and
a conducting portion extending upwardly from a free end of said connecting arm into said second insert groove said conducting portion including a guiding portion and a contact portion, said guiding portion extending obliquely from said second insert groove into said first insert groove, said guiding portion being closer to said first end of said second insert groove than said contact portion, whereby when a mating terminal is inserted into said first end of said second insert groove in the direction of said second end of said second insert groove, said terminal can be guided by said guiding portion to achieve smooth insertion, and can achieve electrical contact with said conducting portion.

2. The electrical connector according to claim 1, wherein said terminal receiving portion is formed by two spaced-apart, juxtaposed spacer plates, said two spacer plates defining said second insert groove of said at least one terminal receiving portion therebetween, said first insert groove being disposed on one of said two spacer plates.

3. The electrical connector according to claim 2, wherein said insulating housing has a mounting face, said first insert groove extending into said mounting face, said connecting portion of said at least one conductive terminal being exposed from said insulating housing at said mounting face.

4. The electrical connector according to claim 1, wherein said body and said connecting arm are disposed on the same vertical plane such that said connecting arm is located in said first insert groove.

5. The electrical connector according to claim 4, wherein said body of said at least one conductive terminal is provided with a plurality of positioning portions for abutting against wall surfaces of said first insert groove so as to achieve interference fit with said first insert groove.

6. The electrical connector according to claim 5, wherein said connecting arm is provided with at least one positioning portion for abutting against a wall surface of said first insert groove so as to achieve interference fit with said first insert groove.

7. The electrical connector according to claim 6 , wherein each of said positioning portions is a projecting block.

8. The electrical connector according to claim 1, wherein said connecting arm of said at least one conductive terminal is bendable relative to said body such that one end of said connecting arm, which is not connected to said body, is closer to said second insert groove than the other end of said connecting arm, which is connected to said body.

9. The electrical connector according to claim 8, wherein said body of said at least one conductive terminal is provided with a plurality of positioning portions for abutting against wall surfaces of said first insert groove so as to achieve interference fit with said first insert groove.

10. The electrical connector according to claim 9, wherein each of said positioning portions is a projecting block.

11. The electrical connector according to claim 1, wherein said connecting arm of said at least one conductive terminal is bendable relative to said body and is insertable into said first insert groove such that said conducting portion is located in said second insert groove and such that said contact portion of said conducting portion and said connecting arm are disposed on the same vertical plane.

12. The electrical connector according to claim 11, wherein said body of said at least one conductive terminal is provided with a plurality of positioning portions for abutting against wall surfaces of said first insert groove so as to achieve interference fit with said first insert groove.

13. The electrical connector according to claim 12, wherein each of said positioning portions is a projecting block.

14. The electrical connector according to claim 11, wherein a surface of said conducting portion of said at least one conductive terminal which faces said second insert groove is a V-shaped plane that projects toward said second insert groove.

15. The electrical connector according to claim 1, wherein said conducting portion of said at least conductive terminal continues to extend upwardly and then reverses to extend in a direction toward said first insert groove such that a surface of said conducting portion which faces said second insert groove is a curved plane projecting toward said second insert groove.

16. The electrical connector according to claim 15, wherein said body of said at least one conductive terminal is provided with a plurality of positioning portions for abutting against wall surfaces of said first insert groove so as to achieve interference fit with said first insert groove.

17. The electrical connector according to claim 16 wherein said connecting arm is provided with at least one positioning portion for abutting against said wall surfaces of said first insert groove so as to achieve interference fit with said first insert groove.

18. The electrical connector according to claim 16, wherein each of said positioning portions is a projecting block.

19. The electrical connector according to claim 17, wherein said connecting portion of said at least one conductive terminal is an insert leg for insertion into an aperture in said circuit board.
